(19) United States
(12) Patent Application Publication
(10) Pub. No.: US 2025/0227711 A1
(43) Pub. Date: Jul. 10, 2025

(54) COMMUNICATION METHOD, COMMUNICATION APPARATUS AND COMMUNICATION DEVICE

(71) Applicant: Beijing Xiaomi Mobile Software Co., Ltd., Beijing (CN)

(72) Inventors: Xuemei QIAO, Beijing (CN); Qin MU, Beijing (CN); Wentao CHENG, Beijing (CN)

(73) Assignee: Beijing Xiaomi Mobile Software Co., Ltd., Beijing (CN)

(21) Appl. No.: 18/850,342

(22) PCT Filed: Mar. 25, 2022
(86) PCT No.: PCT/CN2022/083205

§ 371 Date: Sep. 24, 2024

(51) Int. Cl. H04W 72/23; H04W 24/02

(52) U.S. Cl. CPC H04W 72/23; H04W 24/02

(57) ABSTRACT

A communication method includes: determining, by a network device, processing time of one or more first AI models, wherein the one or more first AI models are one or more neural network models taken by a terminal device for a channel estimation; and determining, by the network device, first PDSCH processing time corresponding to the one or more first AI models based on at least the processing time of the one or more first AI models.

### CROSS-REFERENCE TO RELATED APPLICATION

This application is the U.S. national phase application of International Application No. PCT/CN2022/083205, filed on Mar. 25, 2022, the disclosure of which is incorporated herein by reference in its entirety for all purposes.

### TECHNICAL FIELD

The present disclosure relates to the field of wireless communication technologies, and in particular to a communication method, a communication apparatus and a communication device.

### BACKGROUND

In a fifth generation (5G) mobile communication system, after a terminal device completes receiving a physical downlink shared channel (PDSCH) from a network device, it cannot feed back a hybrid automatic repeat request (HARQ) response signal immediately, but takes some time to process the data transmitted by the PDSCH and also takes some time to prepare a physical uplink control channel (PUCCH). The existing communication protocols (e.g., 3GPP TS 38.214 V16.3.0) defines the above time as PDSCH processing time T_{proc}. The value of T_{proc} is related to a subcarrier spacing of a slot, a demodulation reference signal (DMRS) configuration type used in the PDSCH, a signal processing capability of the user equipment (UE) itself, etc.

At present, with the increasing development of artificial intelligence (AI), AI techniques are being utilized by more and more studies for a channel estimation to eliminate impacts of interference and noise, thereby describing communication channel state information more accurately and improving the performance of the communication system. However, the determination approach of T_{proc} defined in the existing communication protocols cannot meet requirements of new communication scenarios in which AI models have been introduced.

### SUMMARY

The present disclosure provides a communication method, a communication apparatus and a communication device.

According to a first aspect of the present disclosure, a communication method is provided, which is applicable to a network device in a communication system. The method may include: determining, by the network device, processing time of one or more first artificial intelligence (AI) models, wherein the one or more first AI models are one or more neural network models taken by a terminal device for a channel estimation; and determining, by the network device, first physical downlink shared channel (PDSCH) processing time corresponding to the one or more first AI models based on at least the processing time of the one or more first AI models.

According to a second aspect of the present disclosure, a communication method is provided, which is applicable to a network device in a communication system. The method may include: receiving, by the network device, second PDSCH processing capability information from a terminal device, wherein the second PDSCH processing capability information is determined based on complexity information of an AI model and/or type information of the AI model, AI capability information of the terminal device, and third PDSCH processing capability information of the terminal device, and wherein the third PDSCH processing capability information indicate a PDSCH processing capability of the terminal device without performing an AI-based channel estimation; and determining, by the network device, second PDSCH processing time correspondingly based on at least the second PDSCH processing capability information.

According to a third aspect of the present disclosure, a communication method is provided, which is applicable to a terminal device in a communication system. The method may include: receiving, by the terminal device, first PDSCH processing time sent by a network device, wherein the first PDSCH processing time is determined by the network device based on processing time of one or more first AI models, and the one or more first AI models are one or more neural network models taken by the terminal device for a channel estimation; and sending, by the terminal device, uplink control information to the network device in accordance with the first PDSCH processing time.

In the present disclosure, processing time of one or more first AI models are determined based on an AI processing capability of a terminal device, so that a network device can increase the processing time of the first AI model when determining first PDSCH processing time, thereby improving the accuracy and the flexibility of configuring the first PDSCH processing time, and meeting the requirements of new communication scenarios in which an AI-based channel estimation has been introduced.

In addition, one or more corresponding first AI models are determined according to a demodulation reference signal (DMRS) configuration type, so that the network device can increase the processing time of the first AI model when determining the first PDSCH processing time. In this way, by taking into account the impact on a DMRS resource mapping mode when an AI channel estimation is applied, the accuracy and the flexibility of configuring the first PDSCH processing time is improved, and the requirements of new communication scenarios in which an AI-based channel estimation has been introduced are met.

Furthermore, one or more corresponding first AI models are determined according to different channel estimation granularities, so that the network device can increase the processing time of the first AI model in the first PDSCH processing time. In this way, by taking into account the impact of the channel estimation granularity on the PDSCH processing time when the AI channel estimation is applied, the accuracy and the flexibility of configuring the first PDSCH processing time is improved, and the requirements of new communication scenarios in which an AI-based channel estimation has been introduced are met.

### BRIEF DESCRIPTION OF THE DRAWINGS

FIG. 1 is a schematic structural diagram of a communication system in an example of the present disclosure.

FIG. 2 is a schematic flowchart of a first implementation of a communication method on a network device side in an example of the present disclosure.

FIG. 3 is a schematic flowchart of a second implementation of a communication method on a network device side in an example of the present disclosure.

FIG. 4 is a schematic flowchart of a third implementation of a communication method on a network device side in an example of the present disclosure.

FIG. 5A and FIG. 5B are schematic diagrams of DMRS configuration types in an example of the present disclosure.

FIG. 6 is a schematic flowchart of a fourth implementation of a communication method on a network device side in an example of the present disclosure.

FIG. 7 is a schematic flowchart of a fifth implementation of a communication method on a network device side in an example of the present disclosure.

FIG. 8 is a schematic flowchart of a first implementation of a communication method on a UE side in an example of the present disclosure.

FIG. 9 is a schematic flowchart of a second implementation of a communication method on a UE side in an example of the present disclosure.

FIG. 10 is a schematic flowchart of a third implementation of a communication method on a UE side in an example of the present disclosure.

FIG. 11 is a schematic structural diagram of a first communication apparatus in an example of the present disclosure.

FIG. 12 is a schematic structural diagram of a second communication apparatus in an example of the present disclosure.

FIG. 13 is a schematic structural diagram of a third communication apparatus in an example of the present disclosure.

FIG. 14 is a schematic structural diagram of a communication device in an example of the present disclosure.

FIG. 15 is a schematic structural diagram of a terminal device in an example of the present disclosure.

FIG. 16 is a schematic structural diagram of a network device in an example of the present disclosure.

### DETAILED DESCRIPTION OF THE EMBODIMENTS

Embodiments will be described in detail here with the examples thereof illustrated in the drawings. Where the following descriptions involve the drawings, like numerals in different drawings refer to like or similar elements unless otherwise indicated. The implementations described in the following examples do not represent all implementations consistent with the present disclosure. Rather, they are merely examples of apparatuses and methods consistent with some aspects of the present disclosure as detailed in the appended claims.

The terms used in the examples of the present disclosure are for the purpose of describing particular examples only, and are not intended to limit the examples of the present disclosure. Terms determined by “a” and “the” in their singular forms used in the examples of the present disclosure and the appended claims are also intended to include their plural forms, unless clearly indicated otherwise in the context. It is also to be understood that the term “and/or” as used herein is and includes any and all possible combinations of one or more of the associated listed items.

It is to be understood that, although terms “first,” “second,” “third,” and the like may be adopted in the examples of the present disclosure to describe various information, such information should not be limited to these terms. These terms are only used to distinguish the information of the same type with each other. For example, without departing from the scope of the examples of the present disclosure, “first information” may be referred to as “second information”; and similarly, “second information” may also be referred to as “first information”. Depending on the context, the word “if” as used herein may be interpreted as “when”, “upon”, or “in response to determining”.

The technical solutions provided by the examples of the present disclosure are applicable to wireless communications between communication devices. The wireless communication between the communication devices may include: a wireless communication between a network device and a terminal device, a wireless communication between network devices, and a wireless communication between terminal devices. In the examples of the present disclosure, the term “wireless communication” may also be referred to as “communication” for short, and the term “communication” may also be described as “data transmission,” “information transmission” or “transmission”.

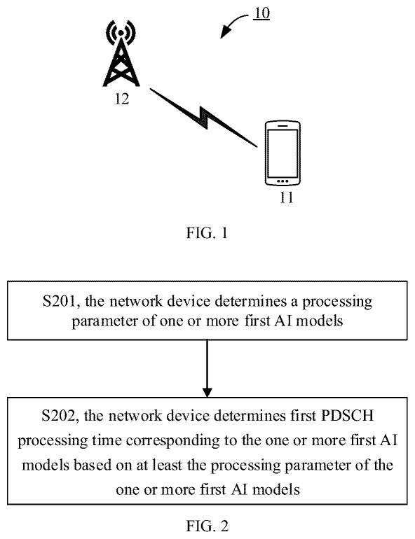

An example of the present disclosure provides a communication system. The communication system may be a communication system adopting cellular mobile communication technologies. FIG. 1 is a schematic structural diagram of a communication system in an example of the present disclosure. As illustrated in FIG. 1, the communication system 10 may include: a terminal device 11 and a network device 12.

In one example, the terminal device 11 may be a device that provides a voice or data connectivity to a user. In some examples, the terminal device may also be referred to as user equipment (UE), mobile station, subscriber unit, station or terminal equipment (TE), etc. The terminal device may be a cellular phone, a personal digital assistant (PDA), a wireless modem, a handheld device, a laptop computer, a cordless phone, a wireless local loop (WLL) station, or a pad, etc. With the development of wireless communication technologies, all devices that can access a communication system, can communicate with the network side of the communication system, or can communicate with other devices through the communication system are terminal devices in the examples of the present disclosure. For example, terminals and cars in intelligent transportations, household devices in smart homes, power meter reading instruments, voltage monitoring instruments and environmental monitoring instruments in smart grids, video monitoring instruments and cash registers in intelligent complete networks, etc. In the examples of the present disclosure, the terminal device may communicate with the network device, and multiple terminal devices may also communicate with each other. The terminal device may be static or mobile. For example, in the following examples, the terminal device is described by taking UE as an example.

The network device 12 may be a device on an access network side and configured to support terminals to access the communication system. The network device 12 may include various forms of macro base stations, micro base stations (which may also be described as small stations), relay stations, access points, etc. In the systems using different wireless access technologies, the name of the network device 12 may be different. For example, it may be an evolved NodeB (eNB) in a 4G access technology communication system, a next generation nodeB (gNB) in a 5G access technology communication system, a transmission reception point (TRP), a relay node, an access point (AP), etc.

The following is a brief introduction to some of the terms and technologies involved in the examples of the present disclosure.

1. Subcarrier spacing. The subcarrier spacing may be one of a subcarrier spacing of a physical downlink shared channel (PDSCH), a subcarrier spacing of a physical downlink control channel (PDCCH) corresponding to the PDSCH and an uplink subcarrier spacing corresponding to the PDSCH, a minimum value of the three, a maximum value of the three, etc.

The PDCCH corresponding to the PDSCH may refer to a PDCCH that schedules the PDSCH. The uplink subcarrier spacing corresponding to the PDSCH may refer to a subcarrier spacing of an uplink channel used when the UE feeds back a response signal (i.e., ACK/NACK) to the network device for the data transmitted on the PDSCH. As an example, if the UE feeds back the ACK/NACK to the network device via a physical uplink control channel (PUCCH), the uplink subcarrier spacing here refers to a subcarrier spacing of the PUCCH. As another example, if the UE feeds back the ACK/NACK to the network device via a physical uplink shared channel (PUSCH), the uplink subcarrier spacing here refers to a subcarrier spacing of the PUSCH.

The detailed description of the subcarrier spacing in the examples of the present disclosure is not limited. In principle, all descriptions that are identical or substantially identical with the feature of “the subcarrier spacing of the PDSCH, the subcarrier spacing of the PDCCH corresponding to the PDSCH, the uplink subcarrier spacing corresponding to the PDSCH, or the minimum value of the three” may be adopted as the definition of the subcarrier spacing. For example, the subcarrier spacing is among the subcarrier spacing of the PDSCH, the subcarrier spacing of the PDCCH and the uplink subcarrier spacing and makes a processing time of the PDSCH calculated satisfy a transmission delay.

### 2. UE Processing Capability

The UE processing capability may represent a capability of UE to process the PDSCH, and may be divided into multiple types such as Capability 1 (UE processing capability 1), Capability 2 (UE processing capability 2), Capability 3 (UE processing capability 3), Capability 4 (UE processing capability 4), and Capability 5 (UE processing capability 5). Through a capability reporting process, the UE may report to the network device which type of PDSCH processing capability it supports. Examples of the UE processing capability may refer to communication protocols according to 3GPP 38.214. For example, the communication protocols according to 3GPP 38.214 provide the values of N₁ corresponding to Capability 1 and Capability 2. The relevant description of d1,1 may be referred to below. The UE processing capability provided in the examples of the present disclosure may be, but not limited to, the processing capability defined in the communication protocols according to 3GPP 38.214.

### 3. PDSCH Processing Time Defined in Existing 3GPP TS 38.214 (v16.3.0)

In 3GPP TS 38.214 (v16.3.0), the PDSCH processing time is calculated by the following formula (1).

$${T}_{proc , 1} = ( {N}_{1} + {d}_{1 , 1} + {d}_{2} ) ( a + b ) \cdot {κ2}^{- μ} \cdot {T}_{C} + {T}_{ext} \qquad ( 1 )$$

N₁ is an important factor that accounts for the largest proportion in formula (1), and includes PDSCH decoding time and PUCCH preparing time, which is related to a subcarrier spacing and a processing capability of the UE itself. d_{1,1} is related to a length of an assigned symbol, and the UE may shorten the actual PDSCH processing time through parallel processing if the assigned symbol is longer, and is to additionally increase the processing time by a certain amount if the parallel processing time is too short due to the shorter symbol. d₂ is reported by the UE itself, which is a parameter related to overlapping between high-priority PUCCH resources and low-priority PUCCH or PUSCH resources, and d₂=0 if no overlapping occurs. T_{C} is a basic sampling time unit, and Tₑₓₜ is a parameter used in an unlicensed spectrum, which are not elaborated. a is the number of sampling points included in one symbol, and b is the number of sampling points included in a cyclic prefix (CP) of one symbol. For example, a=2048 and b=144. The explanations of other parameters in formula (1) may refer to 3GPP TS 38.214 (v16.3.0).

### 4. Artificial Intelligence (AI) Model

The AI model may also be described as a neural network model, a deep learning model, etc. The UE takes the AI model to perform a channel estimation (such as a downlink channel estimation or an uplink channel estimation). Different AI models have different complexities and/or types. That is, the AI model is the neural network model for the channel estimation. Model information of the AI model indicates the complexity and/or the model type of each AI model. For example, the complexity of the AI model may refer to the number of layers contained in the AI model, calculation time, etc. The types of the AI models may include a deep neural network (DNN) model, a convolutional neural networks (CNN) model, a transformer model, etc. It is to be understood that the AI model may also be the neural network model including other complexities and types, which is not specifically limited in the examples of the present disclosure.

In an example, the complexity information of the AI model, and/or the type information of the AI model may be defined in the communication protocols, may be determined based on information sent by the network device (e.g., an AI model index, an AI model parameter, etc.), or may be configured by the network device for the UE, which is not specifically limited in the examples of the present disclosed.

In practical applications, the AI model may be of non-single type and/or non-single complexity, or be of single type and/or single complexity, which is not specifically limited in the examples of the present disclosure.

5. AI processing capability of UE

The AI processing capability refers to a capability of the UE for processing an AI model. In the examples of the present disclosure, the AI processing capability of the UE may be represented by AI capability information. The AI capability information may include at least one of the following parameters: processing time of the UE relative to a baseline model, the number of operations performed by the UE on a single AI model per unit time (i.e., the number of operations of the AI model per unit time), and processing time of the single AI model (which may be understood as the time required for the single AI model to complete one operation). It is to be understood that the AI processing capability of UE may also be represented by other parameters, and accordingly, the AI capability information may also include other parameters, which is not specifically limited in the examples of the present disclosure.

In practical applications, the AI capability information representing the AI processing capability of the UE may be a quantized processing capability, for example, quantized value information, a quantized table preset in the communication protocols, and the like.

In the examples of the present disclosure, a subcarrier spacing of a slot in which the PDSCH is located and a demodulation reference signal (DMRS) configuration type may affect the PDSCH processing time T_{proc} for the network device to schedule the UE. The two together with the processing capability of the UE constitute performance indicators for determining T_{proc}. Important factors affecting T_{proc} may include time for a low density parity check code (LDPC) decoding, a channel estimation, a demodulation, etc. For the channel estimation, if the AI model is taken to replace a linear square (LS) or linear minimum mean squared error (LMMSE) to perform the channel estimation, the processing time of the channel estimation is likely to be increased, and the time taken by the UE to process the PDSCH is also to be increased. Therefore, the time taken by the UE to process the PDSCH is also related to parameters such as the AI model adopted for the channel estimation and the AI processing capability of the UE itself. The approach for determining T_{proc} defined in formula (1) cannot meet the requirements of new communication scenarios in which one or more AI models have been introduced.

In view of the above, a communication method is provided in an example of the present disclosure, which is applicable to the network device of the above communication system.

In the example of the present disclosure, the network device may determine processing time of a downlink channel based on processing time of an AI model to meet the requirements of new communication scenarios in which the AI model has been introduced.

It is to be understood that in the following examples, the above communication method is described by taking a PDSCH as an example of the downlink channel. However, the downlink channel is not limited to the PDSCH, but may be any downlink channel defined in the communication protocols and their evolved versions, for example, a PDCCH, a physical broadcast channel (PBCH), a physical sidelink broadcast channel (PSBCH), a physical sidelink discovery channel (PSDCH), a physical sidelink shared channel (PSSCH), a physical sidelink control channel (PSCCH), etc. The communication methods for different downlink channels may refer to the detailed description in the above examples, which will not be repeated here.

FIG. 2 is a schematic flowchart of a first implementation of a communication method on a network device side in an example of the present disclosure. As illustrated in FIG. 2, the method may include the following steps, S201 and S202.

At S201, the network device determines a processing parameter of one or more first AI models.

The one or more first AI models are one or more neural network models taken by the UE for a channel estimation. Different first AI models have different complexities and/or types. In practical applications, the processing parameter of the first AI model may be processing time of the first AI model, or may be one parameter or one parameter set used for determining the processing time of the first AI model. The processing time of the first AI model may be understood as a time length for which the UE performs the downlink channel estimation by taking the first AI model.

It is to be understood that different AI models differ in complexity, types, etc., so that single processing time of each AI model is also different. Then, in the scenarios where the AI model is taken for the channel estimation, the processing time of different AI models affects the PSDCH processing time. Therefore, when determining the PSDCH processing time of the UE, the network device may first determine the processing time for one or more first AI models.

It is to be noted that the one or more first AI models may be one or more AI models defined in the communication protocols and capable of being taken for the channel estimation, or may be one or more AI models supported by the UE itself and reported by the UE, or may one or more AI models configured for the UE by the network device based on the AI capability information of the UE. It is to be understood that there may also be other situations of the first AI model, which is not specifically limited in the example of the present disclosure.

In some possible implementations, S201 may include that the network device may determine the processing time of the first AI model based on at least one of the following parameters: AI capability information of the UE, complexity information of the AI model, and type information of the AI model.

It is to be understood that the network device traverses the first AI models and determines the processing time of the first AI model based on the known parameter (in which the parameter may include at least one of the following: the AI capability information of the UE, the complexity information of the AI model, and the type information of the AI model).

In practical applications, the AI capability information of the UE may be reported by the UE or defined in the communication protocols.

Then, after obtaining the aforementioned parameter, the network device may determine one or more first AI models according to the AI capability information of the UE, the complexity information of each AI model, and/or the type information of each AI model, and thereby the network device determines the processing time of the first AI models.

It is to be understood that the communication protocols may also define a mapping relationship between the aforementioned parameter and the processing time of the AI models (which may be expressed in form of a quantized table, etc.). Therefore, instead of first determining the first AI models, the network device may directly obtain the processing time of the first AI models based on the aforementioned parameter.

At S202, the network device determines downlink channel processing time corresponding to the one or more first AI models based on at least the processing parameter of the one or more first AI models, where downlink channel processing time is first PDSCH processing time for example.

It is to be understood that after determining the processing time of the first AI model based on the processing parameter of a first AI model in S201, the network device may calculate the first PDSCH processing time based on the processing time of the first AI model.

In practical applications, S202 may include that the network device determines the first PDSCH processing time based on the processing time of the first AI model, a subcarrier spacing, configuration type information of a DMRS, and first PDSCH processing capability information of the UE.

For example, the first PDSCH processing time satisfies the following formula (2) or (3).

$${T}_{proc , 1} = ( {N}_{1} + {d}_{1 , 1} + {d}_{2} + {d}_{3} ) ( a + b ) \cdot {κ2}^{- μ} \cdot {T}_{C} + {T}_{ext} \qquad ( 2 )$$

$${T}_{proc , 1} = ( {N}_{1} + {d}_{1 , 1} + {d}_{2} ) ( a + b ) \cdot {κ2}^{- μ} \cdot {T}_{C} + {T}_{ext} + {d}_{3} \qquad ( 3 )$$

d₃ is a value related to the AI processing capability of the UE, the complexity of the AI model, and/or the type of the AI model. d₃ may be greater than or equal to 0, and d₃ may be less than 0. d₃ represents the processing time of the first AI model. In an example, the explanations and instances of N₁, d_{1,1}, d₂, a, b, μ, κ, T_{C} and Tₑₓₜ in the above formula (2) or (3) may refer to the explanations and instances of N₁, d_{1,1}, d₂, a, b, μ, κ, T_{C} and Tₑₓₜ in 3GPP TS 38.214 (v16.3.0) (which includes a PDSCH processing time formula (such as the formula (1) as above) in the communication protocol whose name is Physical layer procedures for data), respectively. Based on this, it may be considered that the formula (2) or (3), which the PDSCH processing time satisfies and is provided by the example of the present disclosure, adds the parameter of d₃ on the basis of the formula (1) which the PDSCH processing time satisfies and is defined in 3GPP TS 38.214 (v16.3.0) communication protocols.

In some possible implementations, after S202, the network device may schedule transmission resources in accordance with the first PDSCH processing time.

Alternatively, or additionally, the above transmission resources are used for transmitting an uplink channel. It is to be understood that the uplink channel may include any uplink channel defined in the communication protocols and their evolved versions. For example, a PUCCH, a PUSCH, a physical random access channel (PRACH), a physical sidelink feedback channel (PSFCH), etc.

Furthermore, the UE may send at least hybrid automatic repeat request (HARQ) response information (such as ACK/NACK) to the network device on the PUCCH.

In a possible implementation, the network device may also send the first PDSCH processing time to the UE. Thus, the UE may determine the time-frequency positions of the above transmission resources according to the first PDSCH processing time, and then transmit the uplink channel such as the PUCCH, on the transmission resources with the network device.

In the example of the present disclosure, the first PDSCH processing time of the UE is determined based on the processing time of the first AI model, which facilitates configuring the first PDSCH processing time more accurately and flexibly, and meeting the requirements of new communication scenarios in which an AI-based channel estimation has been introduced.

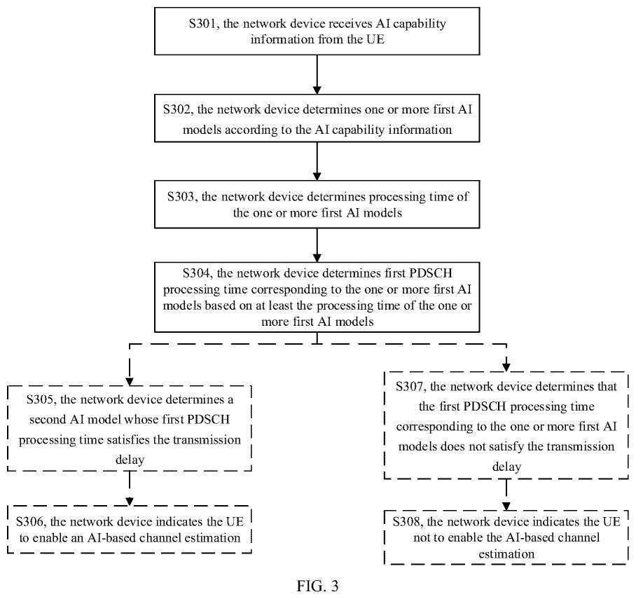

In some possible examples, a communication method is further provided in an example of the present disclosure. FIG. 3 is a schematic flowchart of a second implementation of a communication method on a network device side in an example of the present disclosure. As illustrated in FIG. 3, the method may include the following steps S301-S304.

At S301, the network device receives AI capability information from the UE.

In some possible implementations, the AI capability information of the UE may be the parameters of the UE related to an AI model, or the performance parameters of the UE such as a general processing capability parameter of the UE, which may be collectively referred to as the AI capability information of the UE.

It is to be understood that the AI capability information reported by the UE to the network device may indicate the processing capability of the UE for a single AI model, or may indicate the processing capability of the UE for multiple AI models. Alternatively, the performance parameter of the UE reported by the UE to the network device may indicate the general processing capability of the UE such as UE capability.

For example, for the single AI model, the AI capability information may include at least one of the following parameters: single processing time of the AI model relative to the baseline model, a number of operations of the AI model per unit time, and single processing time of the AI model.

In practical applications, the network device may receive the AI capability information sent by the UE through high-level signaling. For example, the high-layer signaling may be radio resource control (RRC) signaling, medium access control (MAC) control element (CE), and signaling carried by a PUSCH, a PUCCH, etc.

In another example, when sending the AI capability information to the network device, the UE may also send first PDSCH processing capability information to inform the network device of a processing capability of the UE for the PDSCH. The first PDSCH processing capability information may represent the processing capability of the UE for the PDSCH when an AI-based channel estimation is not performed, that is, the UE processing capability defined in 3GPP TS 38.214 (v16.3.0).

Alternatively, or additionally, the AI capability information of the UE and the first PDSCH processing capability information may be carried in the same signaling or in different signaling for sending, which is not specifically limited in the example of the present disclosure.

At S302, the network device determines one or more first AI models according to the AI capability information.

It is to be understood that due to different processing time of different AI models, the processing time of some AI models may satisfy a requirement of a transmission delay, while the processing time of some AI models may not satisfy the requirement of the transmission delay. Therefore, the network device may determine one or more first AI models from a plurality of AI models according to the AI capability information of the UE. The one or more first AI models may be considered as AI model candidates. In this case, the one or more first AI models corresponds to the AI capability information of the UE, which means that the one or more first AI models match the AI model processing capability of the UE, that is, the one or more first AI models are supported by the UE.

At S303, the network device determines processing time of the one or more first AI models.

At S304, the network device determines first PDSCH processing time corresponding to the one or more first AI models based on at least the processing time of the one or more first AI models.

The processes of performing S303 to S304 may refer to the detailed description of S201 to S202 in the example of FIG. 2, which is not repeated here. Similarly, the “one or more first AI models” may be one AI model or be two or more different AI models, which is not limited in the example of the present disclosure.

In some possible implementations, after S304, the network device may schedule transmission resources in accordance with the first PDSCH processing time. The PUCCH may be transmitted on the transmission resources. The UE may send an HARQ response information (such as ACK/NACK) to the network device on at least the PUCCH.

Furthermore, after S304, the network device may also send the first PDSCH processing time to the UE. Thus, the UE may determine the time-frequency positions of the above transmission resources according to the first PDSCH processing time, and then transmit the PUCCH on the transmission resources with the network device.

In some possible implementations, the PDSCH is taken as an example of the downlink channel. Due to different first PDSCH processing time corresponding to different AI models, it may occur that some of the first PDSCH processing time do not satisfy the requirement of the transmission delay. As illustrated by the dotted line in FIG. 3, after S304, the method may further include the following steps, S305-S306.

At S305, the network device determines a second AI model whose first PDSCH processing time satisfies the transmission delay.

At S306, the network device indicates the UE to enable an AI-based channel estimation.

It is to be understood that after calculating the first PDSCH processing time corresponding to the one or more first AI models, the network device may select the first PDSCH processing time that satisfies the requirement of the transmission delay, and take the corresponding first AI model (i.e., the second AI model) as the AI model taken for the UE to perform the channel estimation. Furthermore, since the network device has found the suitable AI model, it may indicate the UE to enable the AI-based channel estimation. As an example, the network device may indicate the UE through high-layer signaling to enable the AI-based channel estimation. For example, the high-level signaling may be signaling carried by RRC signaling, MAC CE, signaling carried by the PDSCH, the PDCCH, etc. Alternatively, the network device may indicate the UE to enable the AI-based channel estimation in a way of indicating the second AI model to the UE.

In S305, after selecting the first PDSCH processing time that meets the requirement of the transmission delay in some possible implementations, the network device schedules the transmission resources in accordance with the first PDSCH processing time. The transmission resources may be configured for transmitting an uplink channel such as a PUCCH. Furthermore, the UE may send HARQ response information (such as ACK/NACK) to the network device on at least the PUCCH.

Furthermore, in S305, after selecting the first PDSCH processing time that meets the requirement of the transmission delay, the network device may also send the first PDSCH processing time corresponding to the second AI model to the UE. Then, the UE may also determine the time-frequency positions of the above transmission resources based on the first PDSCH processing time and a value of K₁ carried by the PDCCH (such as downlink control information (DCI)) that schedules the PDSCH, and then transmit the PUCCH on the transmission resources with the network device. The value of K₁ may refer to the definitions in the communication protocols, which is not specifically limited in the example of the present disclosure.

Still as illustrated by the dotted lines in FIG. 3, after S304 in another example, the method may further include the following steps, S307-S308.

At S307, the network device determines that the first PDSCH processing time corresponding to the one or more first AI models does not satisfy the transmission delay.

At S308, the network device indicates the UE not to enable the AI-based channel estimation.

It is to be understood that after calculating the first PDSCH processing time corresponding to various first AI models, the network device is expected to select the first PDSCH processing time that satisfies the requirement of the transmission delay from them, and adopts the corresponding first AI model (i.e., the second AI model) as the AI model taken for the UE to perform the channel estimation. When the network device finds that no first PDSCH processing time satisfies the requirement of the transmission delay, that is, there is no second AI model, it means that the network device has not found a suitable AI model. Then, the network device may indicate the UE not to enable the AI-based channel estimation. As an example, the network device may indicate the UE through high-layer signaling not to enable the AI-based channel estimation. Alternatively, the network device may indicate the UE not to enable the AI-based channel estimation in a way of not indicating the AI model to the UE.

Alternatively, or additionally, in response to determining that the network device may indicate the UE to enable the AI-based channel estimation through the high-layer signaling, the network device may also indicate the second AI model to the UE. For example, the network device sends the second AI model to the UE. Instead, the network device sends identification information (such as a model index) of the second AI model to the UE, so that the UE may determine the second AI model from the plurality of AI models defined in the communication protocols according to the identification information. Instead, the network device may send relevant parameters of the second AI model to the UE, so that the UE may construct the second AI model by itself according to the relevant parameters. It is to be understood that the network device may also indicate the second AI model to the UE in other ways, which is not specifically limited in the example of the present disclosure.

Alternatively, or additionally, after obtaining the second AI model indicated by the network device, the UE may take the second AI model to perform the channel estimation.

In the example of the present disclosure, by determining the one or more first AI models according to the AI processing capability of the UE, and then determining the first PDSCH processing time based on the processing time of the one or more first AI models, it further improves the accuracy and the flexibility of configuring the first PDSCH processing time, and meets requirements of new communication scenarios in which the AI-based channel estimation has been introduced.

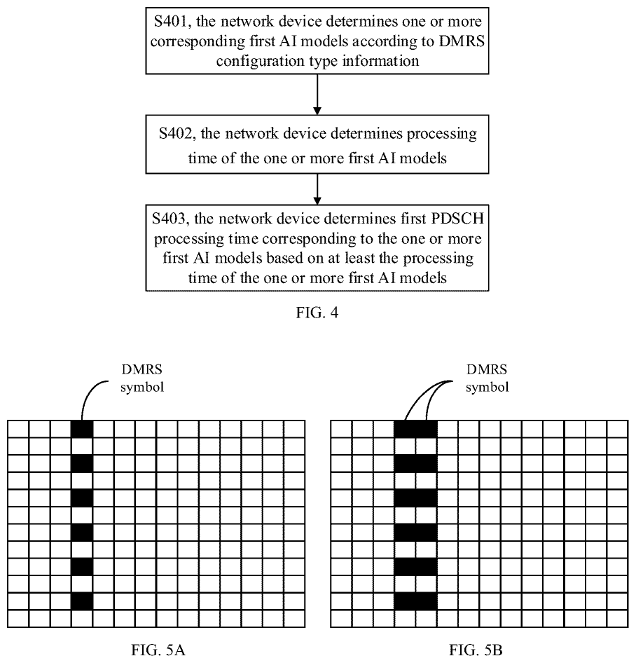

The present disclosure also provides a communication method. FIG. 4 is a schematic flowchart of a third implementation of a communication method on a network device side in an example of the present disclosure. As illustrated in FIG. 4, the method includes the following steps S401-S403.

At S401, the network device determines one or more corresponding first AI models according to DMRS configuration type information.

It is to be understood that as defined in 3GPP TS 38.214 (v16.3.0), whether one or more additional DMRS symbols are used affects the length of the PDSCH processing time. When the UE uses an AI-based channel estimation, the DMRS configuration type may change (e.g., the required DMRS resources are reduced). Difference DMRS configuration types correspond to different AI models. When different DMRS configurations (such as a single-symbol configuration or a dual-symbol configuration) are adopted, the dimensions of the DMRS obtained from the same number of physical resource blocks (PRBs) are different. FIG. 5A and FIG. 5B are schematic diagrams of DMRS configuration types in an example of the present disclosure. As illustrated in FIG. 5A and FIG. 5B, FIG. 5A is a single-symbol configuration, and FIG. 5B is a dual-symbol configuration. The DMRS of different dimensions represent input data of different dimensions and is to be processed by taking different AI models. The processing delays of different AI models vary, which affects the calculation of the PDSCH processing delay. Then, the network device may determine the one or more corresponding first AI models according to the DMRS configuration type information configured for the UE.

In some possible implementations, the DMRS configuration type information indicates whether the UE uses the one or more additional DMRS symbols when performing the AI-based channel estimation, i.e., adopting a single-symbol configuration or a dual-symbol configuration. For example, the single-symbol configuration may mean that no additional DMRS symbol is used, while the double-symbol configuration may mean that the additional DMRS symbol is used.

In some possible implementations, the method may further include that the UE determines the one or more first AI models according to the DMRS configuration type information, and sends the one or more first AI model to the network device, and then the network device performs S402 to S403 according to the one or more first AI models sent by the UE.

At S402, the network device determines processing time of the one or more first AI models.

At S403, the network device determines first PDSCH processing time corresponding to the one or more first AI models based on at least the processing time of the one or more first AI models.

The processes of performing S402 to S403 may refer to the detailed description of S201 to S202 in the example of FIG. 2, which is not repeated here.

In the example of the present disclosure, the one or more first AI models are determined according to the DMRS configuration type, and then the processing time of the first AI model is added in the first PDSCH processing time. In this way, the impact of the DMRS resource mapping mode is taken into account when the AI channel estimation is applied, which meets the requirements of new communication scenarios in which the AI-based channel estimation has been introduced.

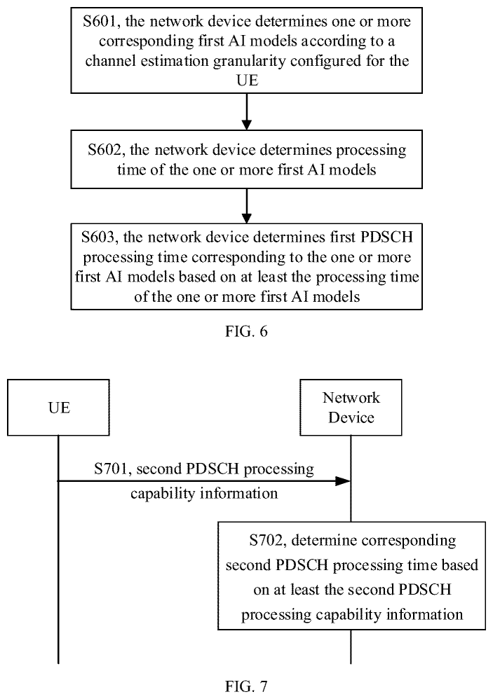

An example of the present disclosure also provides a communication method. FIG. 6 is a schematic flowchart of a fourth implementation of a communication method on a network device side in an example of the present disclosure. As illustrated in FIG. 6, the method includes the following steps, S601-S603.

At S601, the network device determines one or more corresponding first AI models according to a channel estimation granularity configured for the UE.

It is to be understood that when the UE takes the AI model for processing, the channel estimation granularity (i.e., the number of PRBs estimated in a single time) affects a processing speed (i.e., the processing time of the AI model), which in turn affects the determination of the PDSCH processing time. When performing an AI-based channel estimation, the UE may take the AI model to estimate the channels on all PRBs within a transmission bandwidth at one time, or take the AI model to estimate the channels on the PRBs of a certain granularity and repeat it multiple times. Since the dimension of the input data is to be provided when the AI model is trained, different channel estimation granularities correspond to different AI models. For example, a CNN-based structure is adopted to deal with situations where the input data dimension is small, while a Transformer-based structure is adopted to deal with situations where the input data dimension is great. The difference between the channel estimation granularities results in different processing time of the AI model, which in turn affects the PDSCH processing time. Thus, the network device may determine one or more corresponding first AI models according to the channel estimation granularity configured for the UE.

At S602, the network device determines processing time of the one or more first AI models.

At S603, the network device determines first PDSCH processing time corresponding to the one or more first AI models based on at least the processing time of the one or more first AI models.

The processes of performing S602 to S603 may refer to the detailed description of S201 to S202 in the example of FIG. 2, which is not repeated here.

In the example of the present disclosure, the one or more first AI models are determined according to the channel estimation granularity, and then the processing time of the first AI model is added in the first PDSCH processing time. In this way, the impact of the channel estimation granularity on the PDSCH processing time is taken into account when the AI channel estimation is applied, which meets the requirements of new communication scenarios in which the AI-based channel estimation has been introduced.

An example of the present disclosure also provides a communication method. FIG. 7 is a schematic flowchart of a fifth implementation of a communication method on a network device side in an example of the present disclosure. As illustrated in FIG. 7, the method includes the following steps, S701 and S702.

At S701, the network device receives second PDSCH processing capability information from the UE.

The second PDSCH processing capability information is determined by the UE based on complexity information of an AI model and/or type information of the AI model, AI capability information of the UE, and a third PDSCH processing capability information of the UE. The third PDSCH processing capability information refers to PDSCH processing capability information of the UE without performing an AI-based channel estimation, and indicates the PDSCH processing capability when the UE does not perform the AI-based channel estimation.

It is to be understood that the second PDSCH processing capability refers to the PDSCH processing capability of the UE with performing the AI-based channel estimation, which may be considered to be obtained through updating the third PDSCH processing capability for a case where the AI-based channel estimation is performed.

In some possible implementations, according to the definitions of the communication protocols, the second PDSCH processing capability may be divided into multiple types such as Capability 1, Capability 2, Capability 3, and Capability 4. For any type of PDSCH processing capability, the processing time of different AI models may be different.

Correspondingly, when reporting the second PDSCH processing capability, the UE determines which type of capability is met and reports the PDSCH processing capability information corresponding to the type to the network device.

In an example, if the second PDSCH processing capability of the UE does not meet any type of capability defined in the communication protocols, the UE reports the third PDSCH processing capability to the network device, that is, the PDSCH processing capability of the UE without performing the AI-based channel estimation.

At S702, the network device determines corresponding second PDSCH processing time based on at least the second PDSCH processing capability information.

It is to be understood that after receiving the second PDSCH processing capability information sent by the UE through S701, the network device may calculate one or more pieces of second PDSCH processing time based on the second PDSCH processing capability information.

In practical applications, S702 may include that the network device determines the second PDSCH processing time based on a subcarrier spacing, DMRS configuration type information, and the second PDSCH processing capability information of the UE.

As an example, the network device may determine new N₁, which is denoted as N₁, based on the second PDSCH processing capability information of the UE on the basis of the above formula (1). Then, the second PDSCH processing time may satisfy formula (4).

$${T}_{proc , 1} = ( {N}_{1}^{′} + {d}_{1 , 1} + {d}_{2} ) ( a + b ) \cdot {κ2}^{- μ} \cdot {T}_{C} + {T}_{ext} \qquad ( 4 )$$

N₁ is a value related to the subcarrier spacing and the second PDSCH processing capability information. In an example, the explanations and instances of d_{1,1}, d₂, a, b, μ, κ, T_{C}, and Tₑₓₜ in the formula (4) may refer to the explanations and instances of d_{1,1}, d₂, a, b, μ, κ, T_{C}, and Tₑₓₜ in 3GPP TS 38.214 (v16.3.0) (which includes a PDSCH processing time formula (such as the formula (1) as above) in the communication protocol whose name is Physical layer procedures for data), respectively. Based on this, it may be considered that the formula (4) which the PDSCH processing time satisfies and is provided by the example of the present disclosure updates the value of N₁, i.e., N₁, on the basis of formula (1) which the PDSCH processing time satisfies and is defined in 3GPP TS 38.214 (v16.3.0) communication protocols.

In some possible implementations, when reporting the second PDSCH processing capability to the network device, the UE may directly report the second PDSCH processing capability information, or may report the second PDSCH processing capability information consisting of the third PDSCH processing capability information and a corresponding capability increment. As an example, in the above formula (4), the UE may directly report N₁, or may report N₁+Δn (where Δn is the capability increment). It is to be understood that the UE may also report the second PDSCH processing capability in other ways, which is not specifically limited in the example of the present disclosure.

In some possible implementations, after S702, the method further includes that the network device determines a third AI model whose second PDSCH processing time satisfies a transmission delay, and the network device indicates the terminal device to enable the AI-based channel estimation.

It is to be understood that after calculating one or more pieces of second PDSCH processing time based on the second PDSCH processing capability information, the network device is to determine the second PDSCH processing time that meets a transmission delay requirement from the one or more pieces of second PDSCH processing time, and take the corresponding AI model (i.e., the third AI model) as the AI model taken by the UE for the channel estimation. Since the network device has found the suitable AI model, it may indicate the UE to enable the AI-based channel estimation. As an example, the network device may indicate the UE through high-layer signaling to enable the AI-based channel estimation. Alternatively, the network device may indicate the UE to enable the AI-based channel estimation in a way of indicating the third AI model to the UE.

In some other possible implementations, after S702, the method further includes that the network device determines the second PDSCH processing time does not satisfy the transmission delay, and the network device indicates the terminal device not to enable the AI-based channel estimation.

It is to be understood that after determining the one or more corresponding pieces of second PDSCH processing time based on the second PDSCH processing capability information, the network device determines that no second PDSCH processing time satisfies the transmission delay requirement, that is, the network device determines that none of the one or more pieces of the second PDSCH processing time satisfies the transmission delay requirement. In this case, the network device has not found a suitable AI model and may indicate the UE not to enable the AI-based channel estimation. As an example, the network device may indicate the UE through high-layer signaling not to enable the AI-based channel estimation. Alternatively, the network device may indicate the UE not to enable the AI-based channel estimation in a way of not indicating the AI model to the UE.

Alternatively, or additionally, in response to determining that the network device indicates the UE through the high-layer signaling to enable the AI-based channel estimation, the network device may also indicate the third AI model to the UE. For example, the network device sends the third AI model to the UE. Instead, the network device sends identification information (such as a model index) of the third AI model to the UE, so that the UE may determine the third AI model from a plurality of AI models defined in the communication protocols according to the identification information. Instead, the network device may send relevant parameters of the third AI model to the UE, so that the UE may construct the third AI model by itself according to the relevant parameters. It is to be understood that the network device may also indicate the third AI model to the UE in other ways, which is not specifically limited in the example of the present disclosure.

Alternatively, or additionally, after obtaining the third AI model indicated by the network device, the UE may take the third AI model to perform the channel estimation.

In some possible implementations, after S702, the network device may schedule transmission resources in accordance with the second PDSCH processing time corresponding to the third model. The transmission resources may be configured for transmitting an uplink channel such as a PUCCH. Furthermore, the UE may send HARQ response information (such as ACK/NACK) to the network device on at least the PUCCH.

Furthermore, after indicating the UE to enable the AI-based channel estimation, the network device may also send the second PDSCH processing time corresponding to the third AI model to the UE. Thus, the UE may determine the time-frequency positions of the above transmission resources in accordance with the second PDSCH processing time, and then transmit the PUCCH on the transmission resources with the network device.

It is to be noted that the example of the present disclosure is described by taking an example that the PDSCH processing time is determined. In practical applications, the communication method is also be compatible with any downlink channel defined in the communication protocols and their evolved versions, for example, obtaining PDCCH processing time, obtaining PBCH processing time, etc. The detailed determination approaches may refer to the detailed description in the above examples, which is not repeated here.

In the example of the present disclosure, based on the parameter of the UE (for example, at least one of the following: UE processing capability, AI capability information of the UE, complexity information of the AI model, or type information of the AI model), the network device determines the corresponding first PDSCH processing time, thereby further improving the accuracy and the flexibility of configuring the first PDSCH processing time, and meeting the requirements of new communication scenarios in which the AI-based channel estimation has been introduced.

Based on the same inventive concept, an example of the present disclosure also provides a communication method, which is applicable to the UE of the above communication system.

It is to be understood that in the following examples, the communication method is described by taking a PDSCH as an example of a downlink channel. However, the downlink channel is not limited to the PDSCH, but may also be any downlink channel defined in the communication protocols and their evolved versions, for example, a PDCCH, a PBCH, a PSBCH, a PSDCH, a PSSCH, a PSCCH, etc. The communication method for different downlink channels may refer to the detailed description in the above examples, which is not repeated here.

FIG. 8 is a schematic flowchart of a first implementation of a communication method on a UE side in an example of the present disclosure. As illustrated in FIG. 8, the method may include the following steps, S801 and S802.

At S801, the UE receives first PDSCH processing time sent by the network device.

The first PDSCH processing time is determined by the network device based on processing time of one or more first AI models. The one or more first AI models are one or more neural network models taken by the UE for a channel estimation;

At S802, the UE sends uplink control information to the network device in accordance with the first PDSCH processing time.

It is to be understood that after determining the first PDSCH processing time based on the processing time of the one or more first AI models, the network device may send the first PDSCH processing time to the UE. The UE may determine the transmission resources configured by the network device for the UE in accordance with the first PDSCH processing time, and send uplink information such as HARQ response information to the network device on the transmission resources.

Furthermore, the UE may transmit an uplink channel such as a PUCCH on the transmission resources.

In some possible implementations, before S801, the method may further include that the UE sends its own AI capability information to the network device. The AI capability information indicates a processing capability of the UE for an AI model, and is used by the network device to determine the one or more first AI models.

In some possible implementations, the AI capability information includes at least one of the following parameters: single processing time of the AI model relative to a baseline model, a number of operations of the AI model per unit time, and single processing time of the AI model.

In some possible implementations, after the network device indicates the one or more first AI models to the UE, the method may further include that the UE determines a first AI model according to the indication from the network device, and the UE takes the first AI model to perform the channel estimation.

In some possible implementations, after the network device indicates the UE to enable an AI-based channel estimation, the method further includes that the UE receives the indication from the network device for enabling the AI-based channel estimation, and the UE performs the channel estimation according to the indication from the network device.

Alternatively, or additionally, the network device indicates the UE to enable the AI channel estimation in a way of sending an AI model. In this case, after receiving the indication, the UE may take the AI model sent by the network device to perform the channel estimation.

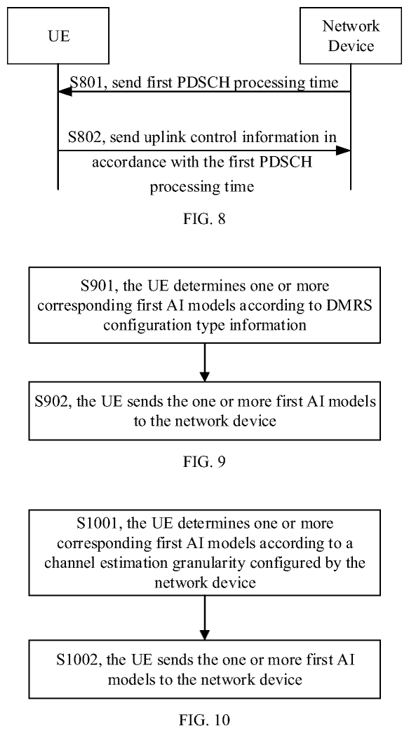

In some possible implementations, FIG. 9 is a schematic flowchart of a second implementation of a communication method on a UE side in an example of the present disclosure. As illustrated in FIG. 9, in response to determining that the network device configures different DMRS resource mapping modes for the UE, the method further includes the following steps, S901 and S902.

At S901, the UE determines one or more corresponding first AI models according to DMRS configuration type information.

At S902, the UE sends the one or more first AI models to the network device.

In this way, the network device may perform S201 to S202 after S902. It is to be understood that after receiving the one or more first AI models reported by the UE, the network device may calculate the corresponding PDSCH processing time based on the processing time of the one or more first AI models, and then determine whether to enable an AI-based channel estimation, etc.

In some possible implementations, the DMRS configuration type information indicated whether one or more additional DMRS symbols are used for the UE to perform the AI-based channel estimation.

It is to be noted that the implementation processes of S901 to S902 on the UE side may refer to the description of the operating processes on the network device side in the example of FIG. 4, which is not repeated here.

In some possible implementations, FIG. 10 is a schematic flowchart of a third implementation of a communication method on a UE side in an example of the present disclosure. As illustrated in FIG. 10, in response to determining that the network device configures different channel estimation granularities for the UE, the method further includes the following steps, S1001 and S1002.

At S1001, the UE determines one or more corresponding first AI models according to a channel estimation granularity configured by the network device.

At S1002, the UE sends the one or more first AI models to the network device.

In this way, the network device may perform S201 to S202 after S1002. It is to be understood that after receiving the one or more first AI models reported by the UE, the network device may calculate the corresponding PDSCH processing time based on the processing time of the one or more first AI models, and then determine whether to enable an AI-based channel estimation, etc.

It is to be noted that the implementation processes of S1001 to S1002 on the UE side may refer to the description of the operating processes on the network device side in the example of FIG. 6, which is not repeated here.

In some possible implementations, in response to the example of FIG. 7, the method further includes that the UE determines the second PDSCH processing capability information based on at least one of the following parameters: complexity information of the AI model, type information of the AI model, AI capability information of the UE, or the third PDSCH processing capability information of the UE. The UE sends the second PDSCH processing capability information to the network device. The second PDSCH processing capability information indicates the network device to determine the first PDSCH processing time.

It is to be noted that the implementation processes of the communication method on the UE side may be combined with the description of the communication methods on the network device side in the examples of FIG. 2 to FIG. 6, which is not repeated here.

It is to be noted that the example of the present disclosure is described by taking an example that the PDSCH processing time is determined. In practical applications, the communication method is also compatible with the processing time of other downlink channels, for example, obtaining PDCCH processing time, obtaining PBCH processing time, etc. The detailed determination approaches may refer to the detailed description in the above examples, which is not repeated here.

In the examples of the present disclosure, according to the above methods, it takes into account the impact of the AI model, the DMRS resource mapping mode when applying the AI channel estimation, or the AI-based channel estimation granularity on determining the downlink channel (e.g., PDSCH) processing time, thereby improving the accuracy and the flexibility of configuring the downlink channel processing time (e.g., the first PDSCH processing time), and meeting the requirements of new communication scenarios in which the AI-based channel estimation has been introduced.

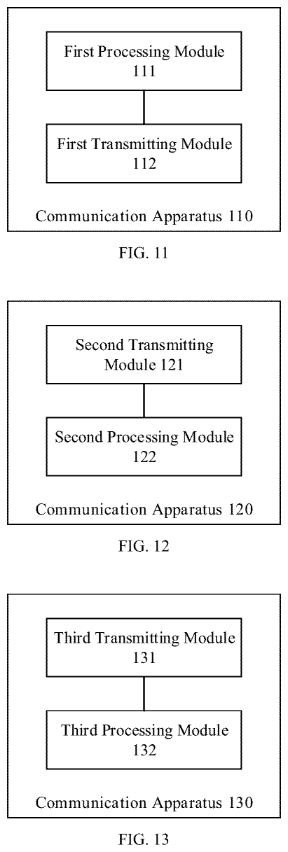

Based on the same inventive concept, a communication apparatus is provided in an example of the present disclosure. The communication apparatus may be a network device in a communication system or a chip or a system-on-chip in the network device. The communication apparatus may also be functional modules in the network device for implementing the methods described in the examples. The communication apparatus may implement the functions performed by the network device in the examples. These functions may be implemented through corresponding software executed by hardware. The hardware or software includes one or more modules corresponding to the functions. FIG. 11 is a schematic structural diagram of a first communication apparatus in an example of the present disclosure. As illustrated in FIG. 11, the communication apparatus 110 includes a first processing module 111 and a first transmitting module 112. The first processing module 111 is configured to determine processing time of one or more first AI models, where the one or more first AI models are one or more neural network models taken by a terminal device for a channel estimation; and the first processing module 111 is configured to determine first PDSCH processing time corresponding to the one or more first AI models based on at least the processing time of the one or more first AI models.

In some possible implementations, the first processing module 111 is configured to determine the processing time of the one or more first AI models based on AI capability information of the terminal device, complexity information of an AI model, and/or type information of the AI model.

In some possible implementations, the first processing module 111 is configured to determine the first PDSCH processing time based on the processing time of the one or more first AI models, a subcarrier spacing, DMRS configuration type information, and first PDSCH processing capability information of the terminal device.

The first transmitting module 112 is configured to receive AI capability information from the terminal device, where the AI capability information indicates a processing capability of the terminal device for an AI model. The first processing module 111 is configured to determine the one or more first AI models according to the AI capability information.

In some possible implementations, the AI capability information includes at least one of the following parameters: single processing time of the AI model relative to a baseline model, a number of operations of the AI model per unit time, and single processing time of the AI model.

In some possible implementations, the first processing module 111 is configured to determine a second AI model whose first PDSCH processing time satisfies a transmission delay. The first transmitting module 112 is configured to indicate the terminal device to enable an AI-based channel estimation.

In some possible implementations, the first transmitting module 112 is further configured to indicate the second AI model to the terminal device after the first processing module 111 determines the second AI model whose first PDSCH processing time satisfies the transmission delay.

In some possible implementations, the first transmitting module 112 is further configured to schedule transmission resources in accordance with the first PDSCH processing time corresponding to the second AI model after the first processing module determines the second AI model whose first PDSCH processing time satisfies the transmission delay.

In some possible implementations, the communication apparatus 110 further includes a first transmitting module 111 that is configured to determine that the first PDSCH processing time does not satisfy a transmission delay. The first transmitting module 112 is configured to indicate the terminal device not to enable an AI-based channel estimation.

In some possible implementations, the first processing module 111 is configured to determine, before determining the processing time of the one or more first AI models, the one or more first AI models correspondingly according to DMRS configuration type information, or the one or more first AI models correspondingly according to a channel estimation granularity configured for the terminal device.

In some possible implementations, the first transmitting module 112 is configured to receive, before the first processing module 111 determines the processing time of the one or more first AI models, the one or more first AI models sent by the terminal device, where the one or more first AI models are determined by the terminal device according to DMRS configuration type information.

In some possible implementations, the DMRS configuration type information indicated whether one or more additional DMRS symbols are used when the terminal device performs an AI-based channel estimation.

It is to be noted that the specific implementation processes of the first processing module 111 and the first transmitting module 112 may refer to the detailed description of the network device in the examples as illustrated in FIG. 2 to FIG. 6, which is not repeated here for the sake of brevity of the specification.

The first transmitting module 112 mentioned in the example of the present disclosure may be a transmitting/receiving interface, a transmitting/receiving circuit or a transceiver, etc. The first processing module 111 may be one or more processors.

Based on the same inventive concept, a communication apparatus is provided in an example of the present disclosure. The communication apparatus may be a network device in a communication system or a chip or a system-on-chip in the network device. The communication apparatus may also be functional modules in the network device for implementing the methods described in the examples. The communication apparatus may implement the functions performed by the network device in the examples. These functions may be implemented through corresponding software executed by hardware. The hardware or software includes one or more modules corresponding to the functions. FIG. 12 is a schematic structural diagram of a second communication apparatus in an example of the present disclosure. As illustrated in FIG. 12, the communication apparatus 120 includes a second transmitting module 121 and a second processing module 122. The second transmitting module 121 is configured to receive second PDSCH processing capability information from a terminal device, where the second PDSCH processing capability information is determined based on complexity information of an AI model and/or type information of the AI model, AI capability information of the terminal device, and third PDSCH processing capability information of the terminal device, and where the third PDSCH processing capability information indicate a PDSCH processing capability of the terminal device without performing an AI-based channel estimation. The second processing module 122 is configured to determine second PDSCH processing time correspondingly based on at least the second PDSCH processing capability information.

In some possible implementations, the second processing module 122 is configured to determine the second PDSCH processing time based on the second PDSCH processing capability information, a subcarrier spacing, and DMRS configuration type information.

In some possible implementations, the second processing module 122 is configured to determine a third AI model whose second PDSCH processing time satisfies a transmission delay. The second transmitting module 121 is configured to indicate the terminal device to enable an AI-based channel estimation.

In some possible implementations, the second transmitting module 121 is configured to indicate the third AI model to the terminal device after the second processing module 122 determines the third AI model whose second PDSCH processing time satisfies the transmission delay.

In some possible implementations, the second transmitting module 121 is configured to schedule transmission resources in accordance with the second PDSCH processing time corresponding to the third AI model after the second processing module 122 determines the third AI model whose second PDSCH processing time satisfies the transmission delay.

In some possible implementations, the second processing module 122 is configured to determine that the second PDSCH processing time does not satisfy a transmission delay. The second transmitting module 121 is configured to indicate the terminal device not to enable an AI-based channel estimation.

It is to be noted that the specific implementation processes of the second transmitting module 121 and the second processing module 122 may refer to the detailed description of the network device in the examples as illustrated in FIG. 7, which is not repeated here for the sake of brevity of the specification.

The second transmitting module 121 mentioned in the example of the present disclosure may be a transmitting/receiving interface, a transmitting/receiving circuit or a transceiver, etc. The second processing module 122 may be one or more processors.

Based on the same inventive concept, a communication apparatus is provided in an example of the present disclosure. The communication apparatus may be a terminal device in a communication system or a chip or a system-on-chip in the terminal device. The communication apparatus may also be functional modules in the terminal device for implementing the methods described in the examples. The communication apparatus may implement the functions performed by the terminal device in the examples. These functions may be implemented through corresponding software executed by hardware. The hardware or software includes one or more modules corresponding to the functions. FIG. 13 is a schematic structural diagram of a third communication apparatus in an example of the present disclosure. As illustrated in FIG. 13, the communication apparatus 130 includes a third transmitting module 131 and a third processing module 132. The third transmitting module 131 is configured to receive first PDSCH processing time sent by a network device, where the first PDSCH processing time is determined by the network device based on processing time of one or more first AI models, and the one or more first AI models are one or more neural network models taken by the terminal device for a channel estimation. And, the third transmitting module 131 is configured to send uplink control information to the network device in accordance with the first PDSCH processing time.

In some possible implementations, the third transmitting module 131 is configured to send own AI capability information to the network device before receiving the first PDSCH processing time sent by the network device. The AI capability information indicates a processing capability of the terminal device for an AI model, and the AI capability information is used by the network device to determine the one or more first AI models.

In some possible implementations, the AI capability information includes at least one of the following parameters: single processing time of the AI model relative to a baseline model, an operation count of the AI model per unit time, and single processing time of the AI model.

The third processing module 132 is configured to determine a first AI model according to an indication from the network device, and perform a channel estimation by taking the first AI model.

In some possible implementations, the third transmitting module 131 is configured to receive, from the network device, an indication for enabling an AI-based channel estimation, and the third processing module 132 is configured to perform a channel estimation according to the indication from the network device.

In some possible implementations, the third processing module 132 is configured to determine the one or more first AI models correspondingly according to DMRS configuration type information. The third transmitting module 131 is configured to send the one or more first AI models to the network device.

In some possible implementations, the DMRS configuration type information indicated whether one or more additional DMRS symbols are used when the terminal device performs an AI-based channel estimation.

In some possible implementations, the third processing module 132 is configured to determine the one or more first AI models correspondingly according to a channel estimation granularity configured by the network device. The third transmitting module 131 is configured to send the one or more first AI models to the network device.

In some possible implementations, the third processing module 132 is configured to determine second PDSCH processing capability information based on complexity information of an AI model and/or type information of the AI model, AI capability information of the terminal device, and third PDSCH processing capability information of the terminal device. The third transmitting module 131 is configured to send the second PDSCH processing capability information to the network device, where the second PDSCH processing capability information indicate the network device to determine first PDSCH processing time.

It is to be noted that the specific implementation processes of the third transmitting module 131 and the third processing module 132 may refer to the detailed description of the UE in the examples as illustrated in FIG. 8 to FIG. 10, which is not repeated here for the sake of brevity of the specification.

The third transmitting module 131 mentioned in the example of the present disclosure may be a transmitting/receiving interface, a transmitting/receiving circuit or a transceiver, etc. The third processing module 132 may be one or more processors.

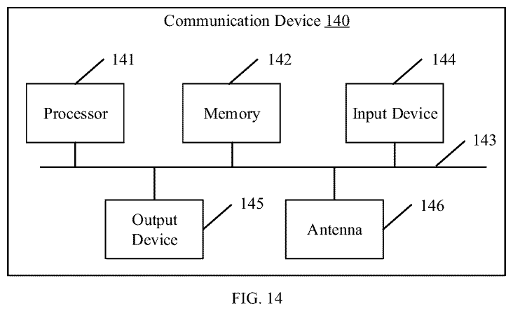

Based on the same inventive concept, a communication device is provided in an example of the present disclosure. The communication device may be the network device or the terminal device described in one or more of the examples. FIG. 14 is a schematic structural diagram of a communication device in an example of the present disclosure. As illustrated in FIG. 14, a communication device 140 adopts general computer hardware, including a processor 141, a memory 142, a bus 143, an input device 144, an output device 145 and an antenna 146.

In some possible implementations, the memory 142 may include computer storage media in the form of a volatile memory and/or a nonvolatile memory, such as a read-only memory and/or a random access memory. The memory 142 may store an operating system, application programs, other program modules, executable codes, program data, user data, and the like.

The input device 144, for example, a keyboard or a pointing device such as a mouse, a trackball, a touch pad, a microphone, a control stick, a game pad, a satellite TV antenna, a scanner or a similar device, may be configured to enter commands and information into the communication device. These input devices may be connected to the processor 141 via the bus 143.

The output device 145 may be configured to output information to the communication device. Besides a monitor, the output device 145 may be another peripheral output device, such as a speaker and/or a printing device. These output devices may also be connected to the processor 141 through the bus 143.

The communication device may be connected to a network, such as a local area network (LAN), via the antenna 146. In a networked environment, the computer-executable instructions stored in the control device may be stored in a remote storage device, rather than being limited to the local storage.

When the processor 141 in the communication device executes the executable codes or the application programs stored in the memory 142, the communication device performs the communication method on the terminal device side or the network device side in the examples. The specific execution process refers to the examples and will not be repeated here.

In addition, the memory 142 stores computer-executable instructions for implementing the functions of the first processing module 111 and the first transmitting module 112 in FIG. 11. All the functions/implementation processes of the first processing module 111 and the first transmitting module 112 in FIG. 11 may be implemented by the processor 141 in FIG. 14 through calling the computer-executable instructions stored in the memory 142. The specific implementation processes and functions refer to the related examples.

Instead, the memory 142 stores computer-executable instructions for implementing the functions of the second transmitting module 121 and the second processing module 122 in FIG. 12. All the functions/implementation processes of the second transmitting module 121 and the second processing module 122 in FIG. 12 may be implemented by the processor 141 in FIG. 14 through calling the computer-executable instructions stored in the memory 142. The specific implementation processes and functions refer to the related examples.

Instead, the memory 142 stores computer-executable instructions for implementing the functions of the third transmitting module 131 and the third processing module 132 in FIG. 13. All the functions/implementation processes of the third transmitting module 131 and the third processing module 132 in FIG. 13 may be implemented by the processor 141 in FIG. 14 through calling the computer-executable instructions stored in the memory 142. The specific implementation processes and functions refer to the related examples.

Based on the same inventive concept, an example of the present disclosure provides a terminal device, which is consistent with the terminal device in one or more of the examples. Alternatively, or additionally, the terminal device may be a mobile phone, a computer, a digital broadcasting terminal, a messaging device, a game console, a pad device, a medical device, a fitness device, a personal digital assistant, and the like.

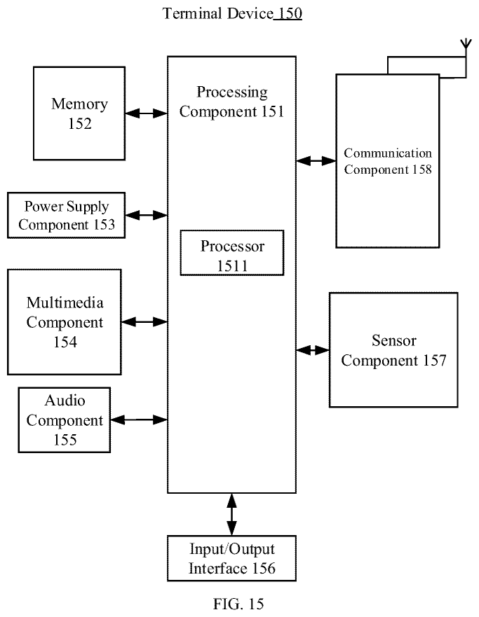

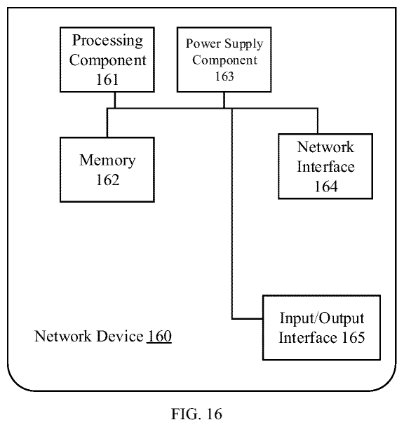

FIG. 15 is a schematic structural diagram of a terminal device in an example of the present disclosure. As illustrated in FIG. 15, the terminal device 150 may include one or more of the following components: a processing component 151, a memory 152, a power supply component 153, a multimedia component 154, an audio component 155, an input/output (I/O) interface 156, a sensor component 157, and a communication component 158.

The processing component 151 generally controls the overall operations of the terminal device 150, such as operations associated with display, phone calls, data communications, camera operations, and recording operations. The processing component 151 may include one or more processors 1511 to execute instructions to complete all or a part of the steps of the above methods. In addition, the processing component 151 may include one or more modules which facilitate the interaction between the processing component 151 and other components. As an example, the processing component 151 may include a multimedia module to facilitate the interaction between the multimedia component 154 and the processing component 151.

The memory 152 is configured to store various types of data to support the operations of the terminal device 150. Examples of such data include instructions for any application or method operated on the terminal device 150, contact data, phonebook data, messages, pictures, videos, and the like. The memory 152 may be implemented by any type of volatile or non-volatile storage device or combination thereof, such as static random access memory (SRAM), electrically erasable programmable read only memory (EEPROM), erasable Programmable Read Only Memory (EPROM), Programmable Read Only Memory (PROM), Read Only Memory (ROM), Magnetic Memory, Flash Memory, Magnetic or Optical Disk.

The power supply component 153 provides power for various components of the terminal device 150. The power supply component 153 may include a power management system, one or more power supplies, and other components associated with generating, managing, and distributing power for the terminal device 150.

The multimedia component 154 includes a screen providing an output interface between the terminal device 150 and a user. In some examples, the screen may include a liquid crystal display (LCD) and a touch panel (TP). If the screen includes the TP, the screen may be implemented as a touch screen to receive input signals from the user. The TP may include one or more touch sensors to sense touches, swipes, and gestures on the TP. The touch sensors may not only sense a boundary of a touch or swipe, but also sense a lasting time and a pressure associated with the touch or swipe. In some embodiments, the multimedia component 154 includes a front-facing camera and/or a rear-facing camera. The front camera and/or rear camera may receive external multimedia data when the terminal device 150 is in an operating mode, such as a photographing mode or a video mode. Each of the front and rear cameras can be a fixed optical lens system or have focal length and optical zoom capability.

The audio component 155 is configured to output and/or input audio signals. For example, the audio component 155 includes a microphone (MIC) that is configured to receive an external audio signal when the terminal device 150 is in an operating mode, such as a call mode, a recording mode, and a voice recognition mode. The received audio signal may be further stored in the memory 152 or transmitted via the communication component 158. In some examples, the audio component 155 also includes a speaker for outputting audio signals.

The I/O interface 156 provides an interface between the processing component 151 and a peripheral interface module. The above peripheral interface module may be a keyboard, a click wheel, buttons, or the like. These buttons may include but not limited to a home button, a volume button, a start button and a lock button.

The sensor component 157 includes one or more sensors to provide the terminal device 150 with status assessments in various aspects. For example, the sensor component 157 may detect an open/closed state of the terminal device 150 and a relative positioning of components such as the display and keypad of the terminal device 150, and the sensor component 157 may also detect a change in position of the terminal device 150 or a component of the terminal device 150, the presence or absence of the target object contacting with the terminal device 150, orientation or acceleration/deceleration of the terminal device 150, and temperature change of the terminal device 150. The sensor component 157 may include a proximity sensor configured to detect the presence of nearby objects in the absence of any physical contact. The sensor component 157 may further include an optical sensor, such as a complementary metal-oxide-semiconductor (CMOS) or charged coupled device (CCD) image sensor which is used in imaging applications. In some examples, the sensor component 157 may also include an acceleration sensor, a gyro sensor, a magnetic sensor, a pressure sensor, or a temperature sensor.

The communication component 158 is configured to facilitate wired or wireless communication between the terminal device 150 and other devices. The terminal device 150 may access a wireless network based on a communication standard, such as WiFi, 2G, 3G, 4G, 5G or a combination thereof. In an example, the communication component 158 receives broadcast signals or broadcast related information from an external broadcast management system via a broadcast channel. In an example, the communication component 158 also includes a near field communication (NFC) module to facilitate short-range communication. For example, the NFC module may be implemented based on a radio frequency identification (RFID) technology, an infrared data association (IrDA) technology, an ultra-wideband (UWB) technology, a Bluetooth® (BT) technology and other technologies.

In one or more examples, the terminal device 150 may be implemented by one or more application specific integrated circuits (ASIC), digital signal processors (DSP), digital signal processing equipment (DSPD), programmable logic devices (PLD), field programmable gate array (FPGA), controller, microcontroller, microprocessor, or other electronics to perform the foregoing methods.

By adopting the same inventive concept, a network device is provided in an example of the present disclosure. The network device is consistent with the network device in one or more of the examples.

FIG. 16 is a schematic structural diagram of a network device in an example of the present disclosure. As illustrated in FIG. 16, the network device 160 may include a processing component 161 that further includes one or more processors (not shown), and memory resources represented by a memory 162 for storing instructions that may be executed by the processing component 161, such as an application. The application programs stored in the memory 162 may include one or more modules, each of which corresponds to a set of instructions. In addition, the processing component 161 is configured to execute instructions to perform any one of the foregoing methods applied to the network device.

The network device 160 may also include a power supply component 163 which is configured to perform power management for the network device 160, a wired or wireless network interface 164 which is configured to connect the network device 160 to a network, and an input/output (I/O) interface 165. The network device 160 may perform operations by adopting an operating system stored in memory 162, such as Windows Server™, Mac OS X™, Unix™, Linux™, FreeBSD™, or the like.

Based on the same inventive concept, a non-transitory computer-readable storage medium is further provided in an example of the present disclosure. The non-transitory computer-readable storage medium stores instructions. The instructions, when executed on a computer, are configured to perform the communication methods on the terminal device side or the network device side as described in one or more of the examples.

Based on the same inventive concept, a computer program or a computer program product is further provided in an example of the present disclosure. The computer program product, when executed on a computer, enables the computer to implement the communication methods on the terminal device side or the network device side as described in one or more of the examples.

Other implementations of the present disclosure will be readily apparent to those skilled in the art after implementing the disclosure by referring to the specification. The present disclosure is intended to cover any variations, uses, or adaptations of the present disclosure that are in accordance with the general principles thereof and include common general knowledge or conventional technical means in the art that are not disclosed in the present disclosure. The description and the examples are only illustrative, and the true scope and spirit of the present disclosure are set forth in the appended claims.

It should be understood that the present disclosure is not limited to the above-described accurate structures illustrated in the drawings, and various modifications and changes can be made to the present disclosure without departing from the scope thereof. The scope of the present disclosure is to be limited only by the appended claims.

1. A communication method, comprising:
determining, by a network device, processing time of one or more first artificial intelligence (AI) models, wherein the one or more first AI models are one or more neural network models taken by a terminal device for a channel estimation; and
determining, by the network device, first physical downlink shared channel (PDSCH) processing time corresponding to the one or more first AI models based on at least the processing time of the one or more first AI models.

2. The method according to claim 1, wherein determining, by the network device, the processing time of the one or more first AI models comprises:
determining, by the network device, the processing time of the one or more first AI models based on at least one of AI capability information of the terminal device, complexity information of an AI model, or type information of the AI model.

3. The method according to claim 1, wherein determining, by the network device, the first PDSCH processing time corresponding to the one or more first AI models based on at least the processing time of the one or more first AI models comprises:
determining, by the network device, the first PDSCH processing time based on the processing time of the one or more first AI models, a subcarrier spacing, demodulation reference signal (DMRS) configuration type information, and first PDSCH processing capability information of the terminal device.

4. The method according to claim 1, further comprising:
receiving, by the network device, AI capability information from the terminal device, wherein the AI capability information indicates a processing capability of the terminal device for an AI model; and
determining, by the network device, the one or more first AI models according to the AI capability information.

5. (canceled)

6. The method according to claim 1,
further comprising:
determining, by the network device, a second AI model whose first PDSCH processing time satisfies a transmission delay; and
indicating, by the network device, the terminal device to enable an AI-based channel estimation; or
further comprising:
determining, by the network device, that the first PDSCH processing time does not satisfy a transmission delay; and
indicating, by the network device, the terminal device not to enable an AI-based channel estimation.

7. The method according to claim 6, wherein after determining, by the network device, the second AI model whose first PDSCH processing time satisfies the transmission delay, the method further comprises at least one of:
indicating, by the network device, the second AI model to the terminal device; or
scheduling, by the network device, transmission resources in accordance with the first PDSCH processing time corresponding to the second AI model.

8-9. (canceled)

10. The method according to claim 1, wherein before determining, by the network device, the processing time of the one or more first AI models, the method further comprises:
determining, by the network device, the one or more first AI models correspondingly according to demodulation reference signal (DMRS) configuration type information; or
determining, by the network device, the one or more first AI models correspondingly according to a channel estimation granularity configured for the terminal device; or
receiving, by the network device, the one or more first AI models sent by the terminal device, wherein the one or more first AI models are determined by the terminal device according to demodulation reference signal (DMRS) configuration type information.

11-12. (canceled)

13. A communication method, comprising:
receiving, by a network device, second physical downlink shared channel (PDSCH) processing capability information from a terminal device, wherein the second PDSCH processing capability information is determined based on complexity information of an artificial intelligence (AI) model, type information of the AI model, AI capability information of the terminal device, and third PDSCH processing capability information of the terminal device, and wherein the third PDSCH processing capability information indicate a PDSCH processing capability of the terminal device without performing an AI-based channel estimation; and
determining, by the network device, second PDSCH processing time correspondingly based on at least the second PDSCH processing capability information.

14. The method according to claim 13, wherein determining, by the network device, the second PDSCH processing time based on at least the second PDSCH processing capability information comprises:
determining, by the network device, the second PDSCH processing time based on the second PDSCH processing capability information, a subcarrier spacing, and demodulation reference signal (DMRS) configuration type information.

15. The method according to claim 13,
further comprising:
determining, by the network device, a third AI model whose second PDSCH processing time satisfies a transmission delay; and
indicating, by the network device, the terminal device to enable an AI-based channel estimation; or
further comprising:
determining, by the network device, that the second PDSCH processing time does not satisfy a transmission delay; and
indicating, by the network device, the terminal device not to enable an AI-based channel estimation.

16. The method according to claim 15, wherein after determining, by the network device, the third AI model whose second PDSCH processing time satisfies the transmission delay, the method further comprises at least one of:
indicating, by the network device, the third AI model to the terminal device; or
scheduling, by the network device, transmission resources in accordance with the second PDSCH processing time corresponding to the third AI model.

17-18. (canceled)

19. A communication method, comprising:
receiving, by a terminal device, first physical downlink shared channel (PDSCH) processing time sent by a network device, wherein the first PDSCH processing time is determined by the network device based on processing time of one or more first artificial intelligence (AI) models, and the one or more first AI models are one or more neural network models taken by the terminal device for a channel estimation; and
sending, by the terminal device, uplink control information to the network device in accordance with the first PDSCH processing time.

20. The method according to claim 19, wherein before receiving, by the terminal device, the first PDSCH processing time sent by the network device, the method further comprises:
sending, by the terminal device, own AI capability information to the network device, wherein the own AI capability information indicates a processing capability of the terminal device for an AI model, and the own AI capability information is used by the network device to determine the one or more first AI models.

21. (canceled)

22. The method according to claim 19,
further comprising:
determining, by the terminal device, a first AI model according to an indication from the network device; and
performing, by the terminal device, a channel estimation by taking the first AI model; or
further comprising:
receiving, by the terminal device and from the network device, an indication for enabling an AI-based channel estimation; and
performing, by the terminal device, a channel estimation according to the indication from the network device.

23. (canceled)

24. The method according to claim 19, further comprising:
determining, by the terminal device, the one or more first AI models correspondingly according to demodulation reference signal (DMRS) configuration type information; or
determining, by the terminal device, the one or more first AI models correspondingly according to a channel estimation granularity configured by the network device;
and further comprising:
sending, by the terminal device, the one or more first AI models to the network device.

25. The method according to claim 24, wherein the DMRS configuration type information indicated whether one or more additional DMRS symbols are used when the terminal device performs an AI-based channel estimation.

26. (canceled)

27. The method according to claim 19, further comprising:
determining, by the terminal device, second PDSCH processing capability information based on at least one of complexity information of an AI model or type information of the AI model, AI capability information of the terminal device, and third PDSCH processing capability information of the terminal device; and
sending, by the terminal device, the second PDSCH processing capability information to the network device, wherein the second PDSCH processing capability information indicate the network device to determine first PDSCH processing time.

28-54. (canceled)

55. A communication device, comprising:
an antenna;
a memory; and
a processor, connected to the antenna and the memory, and configured to execute computer-executable instructions stored in the memory to control receptions and transmissions of the antenna and implement the communication method according to claim 1.

56. (canceled)

57. A communication device, comprising:
an antenna;
a memory; and
a processor, connected to the antenna and the memory, and configured to execute computer-executable instructions stored in the memory to control receptions and transmissions of the antenna and implement the communication method according to claim 13.

58. A communication device, comprising:
an antenna;
a memory; and
a processor, connected to the antenna and the memory, and configured to execute computer-executable instructions stored in the memory to control receptions and transmissions of the antenna and implement the communication method according to claim 19.
